(19) United States
(12) Patent Application Publication
(10) Pub. No.: US 2008/0259502 A1
(43) Pub. Date: Oct. 23, 2008

(54) MAGNETIC HEAD SLIDER

(76) Inventors: Yuki SHIMIZU, Yokohama (JP); Junguo Xu, Kasumigaura (JP); Jianhua Li, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/099,801

(22) Filed: Apr. 9, 2008

(30) Foreign Application Priority Data
Apr. 13, 2007 (JP) P2007-105981

(51) Int. Cl. G11B 5/60

(52) U.S. Cl. 360/235.8

(57) ABSTRACT

A magnetic head slider has a recess portion recessed with respect to the center rail. The recess portion has a spherical or oval-spherical projection, which includes a read element and a write element disposed in the recess portion. The recess portion may prevent increasing flying height of a slider base due to projection height h may be suppressed, and may secures higher air film stiffness, so that consequently flying stability of the slider may be improved.

### CLAIM OF PRIORITY

The present application claims priority from Japanese application serial no. P2007-105981, filed on Apr. 13, 2007, the content of which is hereby incorporated by reference into this application.

### BACKGROUND OF THE INVENTION

1. Field of the Invention

The present invention relates to a magnetic head slider mounted on a magnetic disk drive.

2. Description of the Related Art

In a magnetic disk drive, as a space between a recording layer on a magnetic disk and a read/write element on a magnetic head slider is reduced, information recording density may be increased. Therefore, with improvement in information recording density of a magnetic disk drive, low-flying of a magnetic head slider has been progressively developed. Flying height of the magnetic head slider above a magnetic disk, that is, a distance from a magnetic disk surface to a lowest flying point of the magnetic head slider during flying is currently reduced to about 10 nm as a designed value, which means that the magnetic head slider has substantially no flying margin in the light of variation in flying height of the magnetic head slider along with change in temperature of the magnetic disk drive, and change in atmospheric pressure within or surrounding the magnetic disk drive.

JP7-254248A discloses a technique of providing spherical convex-portions back and forth, or horizontally symmetrically on a flat surface of an air-bearing surface in order to stabilize flying height of the magnetic head slider. Moreover, JP2006-196137A discloses a technique that a spherical or oval-spherical projection is formed in a part of an air bearing surface at a back side of the slider, and a recording/reproducing head is disposed near a peak of the projection, so that flying height of the magnetic head slider is stabilized.

As described above, in the magnetic head slider, the spherical or oval-spherical projection is formed on the flat surface of the air-bearing surface, and thus when a surface of the magnetic head slider is contacted to a magnetic disk surface, the spherical or oval-spherical projection is contacted to the disk surface, thereby a side of the magnetic head slider surface is reduced in contact friction force, so that flying height of the magnetic head slider can be stabilized. However, in the air-bearing surface of the magnetic head slider, when the spherical or oval-spherical projection is formed on a thin-film magnetic head section at an air outflow end side, a space between a base of the magnetic head slider and the disk surface is increased by a height of the projection, leading to reduction in air film stiffness during flying of the magnetic head slider. When the air film stiffness is reduced, flying stability is accordingly reduced, consequently the slider cannot follow undulation or vibration of the disk surface.

### SUMMARY OF THE INVENTION

This invention provides a magnetic head slider, by which even if the spherical or oval-spherical projection is formed on a center rail, and a read element and a write element are disposed on the projection, higher air film stiffness may be secured.

This invention also provides a magnetic head slider having excellent flying-following.

A magnetic head slider of the invention, a recess portion, which is recessed with respect to a center rail formed on an air-bearing surface of the slider and a thin-film magnetic head section, is provided in the center rail, and a spherical or oval-spherical projection having a height at a position projecting from the center rail is formed in the recess portion, and a read element and a write element are disposed in a position including a peak of the projection.

The read element has a lower magnetic shield, a magnetoresistive element, and an upper magnetic shield, and the write element is stacked at a side of an air outflow end of the read element, and the read element and the write element are disposed as a whole in a certain position on the projection.

Center rail portions desirably exist at both sides of the projection.

Moreover, in a magnetic head slider of the invention, a recess portion, which is recessed with respect to a center rail formed on an air-bearing surface of the slider and a thin-film magnetic head section, is provided in the center rail, and a read element, write element, and heater are disposed in the recess portion.

A region including the read element and the write element is projected to an air-bearing surface side due to thermal deformation caused by heat generation of the heater, consequently a peak of a projected portion becomes higher than a center rail surface.

According to the invention, in a magnetic head slider, even if a spherical or oval-spherical projection is formed on a center rail, and a read element and a write element are disposed on the projection, higher air film stiffness may be secured, consequently flying stability may be improved. Moreover, center rail portions are provided at both sides of the projection, thereby flying-following may be improved.

### BRIEF DESCRIPTION OF THE DRAWINGS

FIG. 1 is an exemplary air view showing a shape of an air-bearing surface of a magnetic head slider 1 according to example 1 of the invention.

FIG. 2A shows an exemplary enlarged diagram of a region near a center pad in FIG. 1. FIG. 2B shows an enlarged diagram thereof seen from an outflow end side of the slider.

FIG. 3 is an exemplary enlarged section diagram of a thin-film magnetic head section in FIG. 1.

FIG. 4 is exemplary side diagrams of a usual magnetic head slider in flying.

FIGS. 5A and 5B are exemplary diagrams showing calculation results of air film stiffness K11 against translational motion in a flying height direction of the slider (a), and calculation results of air film stiffness K22 against vibration in a slider pitch direction (b), in the usual magnetic head slider.

FIG. 6 is exemplary diagrams for illustrating an effect of the magnetic head slider according to Example 1, wherein (a) shows a side diagram of a usual slider in flying, in which a projection is formed on a center rail surface, and (b) shows a side diagram of the magnetic head slider according to Example 1 in flying.

FIGS. 7A and 7B are exemplary diagrams for illustrating an effect of the magnetic head slider according to Example 1, wherein FIG. 2A shows a diagram showing calculation results of air film stiffness K11 against translational motion in a flying height direction of the slider, and FIG. 2B shows a diagram showing calculation results of air film stiffness K22 against vibration in a slider pitch direction.

FIG. 8 is an exemplary diagram for illustrating an effect of the magnetic head slider according to Example 1, showing calculation results of disk-undulation-following.

FIGS. 9A and 9B are exemplary plane diagrams of an air-bearing surface of the magnetic head slider according to Example 1.

FIGS. 10A and 10B are exemplary diagrams showing calculation results of air film stiffness between the air-bearing surface of the magnetic head slider and a magnetic disk surface from dynamic analytical calculation of flying with width W of each of center rail portions at both sides of a recess portion as a parameter, in the magnetic head slider according to Example 1.

FIG. 11 is an exemplary diagram showing calculation results of disk-undulation-following of a magnetic head slider from dynamic analytical calculation of flying with width W of each of center rail portions at both sides of a recess portion as a parameter.

FIG. 12 is an exemplary sectional diagram of a thin film head section of a magnetic head slider according to Example 2.

FIG. 13 is an exemplary plane diagram of a heater of the magnetic head slider according to Example 2.

### DESCRIPTION OF THE PREFERRED EMBODIMENT

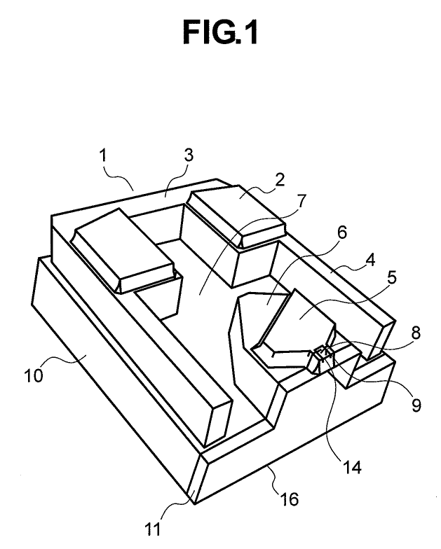

Hereinafter, a configuration of a magnetic head slider according to Example 1 of the invention is described with reference to drawings. FIG. 1 shows an air view showing an air-bearing surface of a magnetic head slider 1. The magnetic head slider 1 is configured by a slider 10, and a thin film magnetic head section 11 formed at an air outflow end of the slider 10. The air-bearing surface of the magnetic head slider 1 includes a front pad configured by front rails 2 and a front step bearing 3; a center pad configured by a side step bearing 4 continued from the front step bearing 3, a center rail 5, and a center step bearing 6; and a negative-pressure groove 7 isolating the pads from each other. The center rail 5 is formed extending over the slider 10 and the thin film magnetic head section 11. The front pad, center pad, and negative-pressure groove may be formed by etching such as ion milling. Depth of the negative-pressure groove 7 is formed deep compared with the front step bearing 3, side step bearing 4, and center step bearing 6. The read element 8 and the write element 9 are formed in the thin film magnetic head section 11, and situated near an air outflow end of the center rail 5.

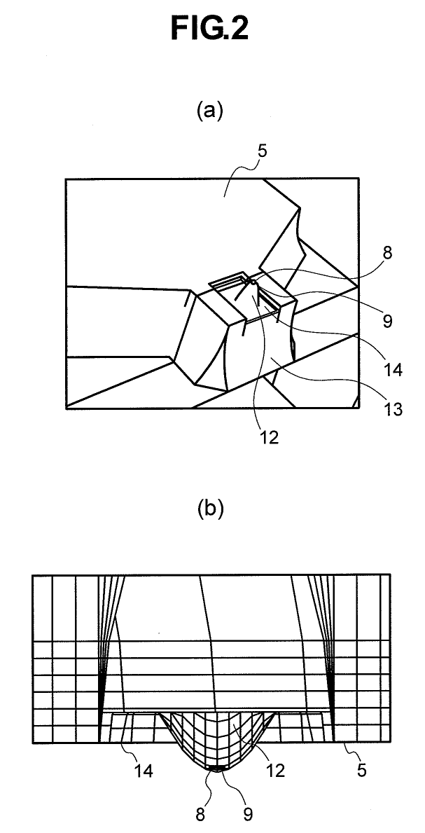

The slider 10 includes alumina-titanium carbide (AlTiC: Al₂O₃—TiC), and the thin film magnetic head section 11 includes alumina (Al₂O₃). FIG. 2A shows an enlarged diagram of a region near the center rail 5, wherein a recess portion 14 is formed in the center rail 5 of the center pad, the recess portion being recessed with respect to the center rail, and a spherical or oval-spherical projection 12 is formed on the recess portion 14. The read element 8 and the write element 9 are disposed in a position including a peak of the projection 12. A view of a shape of the slider seen from a side of an outflow end face 13 is shown in FIG. 2B. However, FIG. 2B is a vertically inverse diagram to FIG. 2A, in which the projection 12 is seen with being protruded at a lower side of the figure.

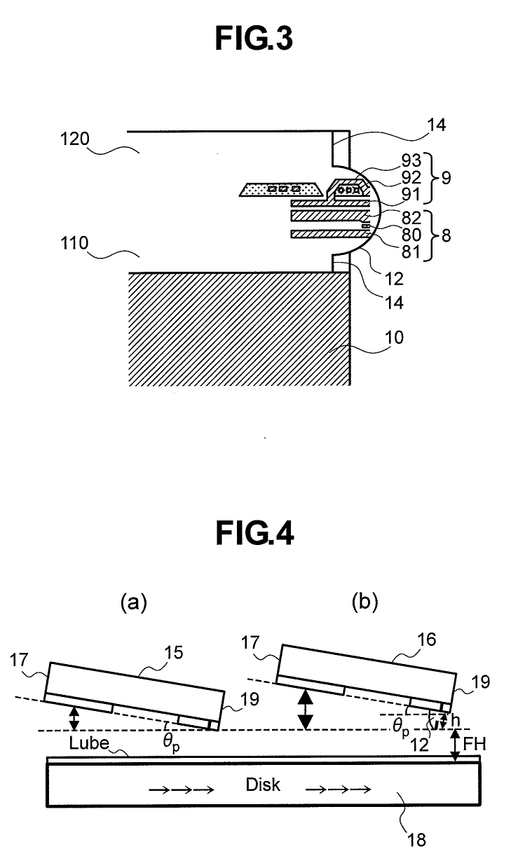

FIG. 3 shows a sectional diagram of a portion of the projection 12 taken in a longitudinal direction of the slider. The read element 8 and the write element 9 are formed on the AlTiC substrate 10 via an alumina base layer 110 by a thin film formation process. The read element 8 includes a magnetoresistive head configured by a lower magnetic shield 81, a magnetoresistive element 80, and an upper magnetic shield 82; and the write element 9 includes an induction magnetic head configured by a lower magnetic core 91, a coil 92, and an upper magnetic core 93 stacked on the air outflow side of the read element 8. An alumina hard protective layer 120 is stacked on the write element 9. Regarding the spherical or oval-spherical projection 12, which may be formed, for example, by a method described in the patent document 1 or 2, the thin film magnetic head section 11 is formed on the AlTiC substrate 10, then the AlTiC substrate 10 is cut into individual magnetic head sliders, and then regions in which the recess portion and the projection are to be formed are masked during forming the air-bearing surface, and regions other than the regions in which the recess portion and the projection are to be formed are removed by about 5 nm by using ion milling. Then, the projection 12 is formed, and then in order to form the recess portion 14 around the projection 12, a region for forming the projection and the outside of a region for forming the recess portion are masked, and then the region for forming the recess portion is further removed by about 5 nm by using ion milling. In this process, a plurality of masks, each having different area, are prepared as masks for the region for forming the projection, and ion milling is performed while the masks are sequentially changed from a mask having smaller area to a mask having larger area, thereby the spherical or oval-spherical projection 12 may be formed. Moreover, the recess portion 14 having a depth of about 10 nm may be formed around the projection 12.

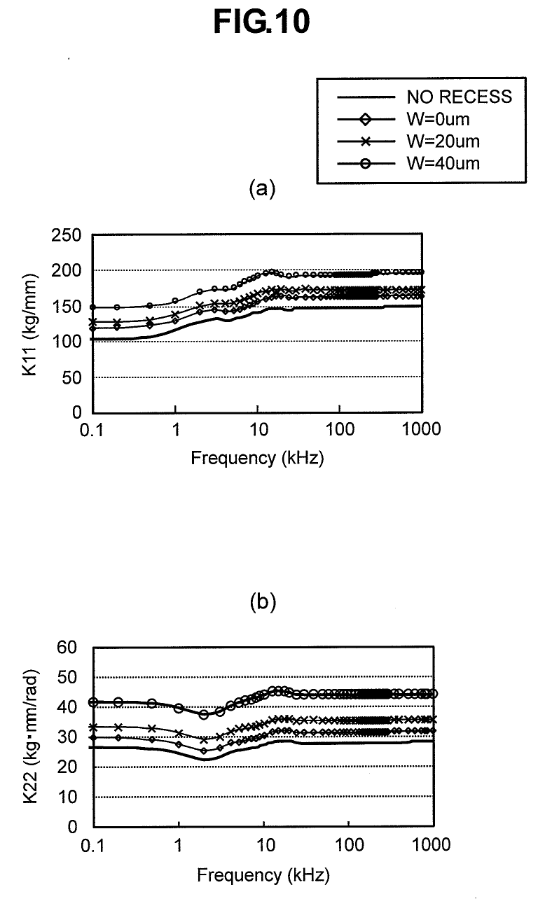

An effect given by the configuration is described using FIGS. 4 to 7. FIG. 4 shows a schematic diagram of a magnetic head slider in flying above a magnetic disk, which is seen from a side. (a) of FIG. 4 shows a typical magnetic head slider 15 in the past (for example, refer to FIGS. 10A and 10B in the patent document 2), and (b) of FIG. 4 shows a magnetic head slider 16 in which the spherical or oval-spherical projection 12 is formed on a center rail (for example, refer to FIG. 1 in the patent document 1). Typically, each of the magnetic head sliders 15 and 16 flies above the magnetic disk 18 being rotated in such an attitude that a gap between each of the magnetic head sliders 15, 16 and the magnetic disk 18 at an air inflow end 17 is large compared with a gap between each of the magnetic head sliders 15, 16 and the magnetic disk 18 at an air outflow end 19, that is, flies above the disk with a pitch angle θp.

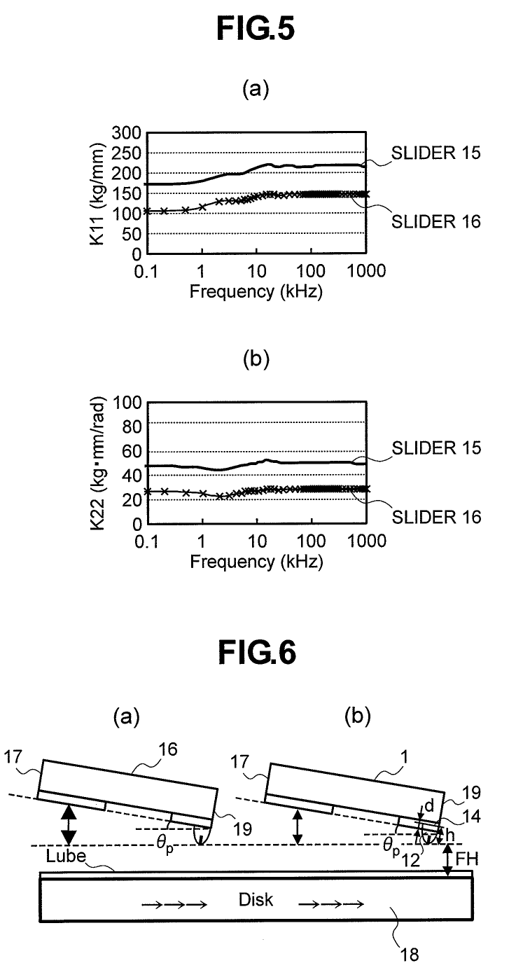

Here, when flying height FH at the read element 8 or the write element 9 is made even between the magnetic head sliders 15 and 16, the magnetic head slider 16 having the projection 12 formed on the center rail is high in flying height of a slider base by height h of the projection 12 compared with the typical magnetic head slider 15 in the past. That is, the whole air-bearing surface of the slider is more away from a surface of the magnetic disk 18 except for the projection 12, leading to reduction in air film stiffness formed between the air-bearing surface of the slider and the disk surface. FIGS. 5A and 5B show calculation results of the air film stiffness of the magnetic head sliders 15 and 16 from “Analytical simulation of viscous fluid based on modified Reynolds equation” as dynamic analytical calculation of flying of a magnetic head slider. A horizontal axis of FIG. 5A shows frequency, and a vertical axis thereof shows air film stiffness (spring modulus) K11 against translational motion in a flying height direction of the slider, and a horizontal axis of FIG. 5B shows frequency, and a vertical axis thereof shows air film stiffness (spring modulus) K22 against vibration in a slider pitch direction. In each graph, calculation results for the magnetic head sliders 15 and 16 are plotted in rows. In this calculation, the pitch angle Op and the flying height FH at the read element 8 or the write element 9 were made even respectively between respective analytical models. The height h of the spherical or oval-spherical projection was assumed to be 10 nm. From FIGS. 5A and 5B, it is known that air film stiffness ΔK11 is reduced by about 30%, and ΔK22 is reduced by about 20% by providing the projection 12.

On the contrary, in the magnetic head slider 1 of Example 1, since the spherical or oval-spherical projection 12 including the read element 8 and the write element 9 is disposed on the recess portion 14, which is recessed with respect to the center rail 5 of the center pad, as shown in FIG. 2B, increase in flying height of the slider base due to the projection height h may be suppressed, consequently higher air film stiffness may be secured.

FIG. 6 shows a schematic diagram of a magnetic head slider in flying above a magnetic disk when it is seen from an air outflow side. (a) of FIG. 6 shows the magnetic head slider 16 in which the spherical or oval-spherical projection 12 is formed on the center rail 5 as shown in (b) of FIG. 4, and (b) of FIG. 6 shows the magnetic head slider 1 according to Example 1. Both the magnetic head sliders 1 and 16 fly above the magnetic disk 18 being rotated with a pitch angle Op.

Here, flying height FH at the read element 8 or the write element 9 is made even between the magnetic head sliders 1 and 16, the magnetic head slider 1 of Example 1, in which the spherical or oval-spherical projection 12 is formed on the recess portion 14 being recessed with respect to the center rail 5 of the center pad, is low in flying height of the slider base by recess depth d of the recess portion 14 compared with the magnetic head slider 16 having the projection 12 formed on the center rail 5 of the center pad. That is, the whole air-bearing surface of the slider approaches a surface of the magnetic disk 18 except for the projection 12, consequently certain stiffness of an air film formed between the air-bearing surface of the slider and the disk surface may be secured.

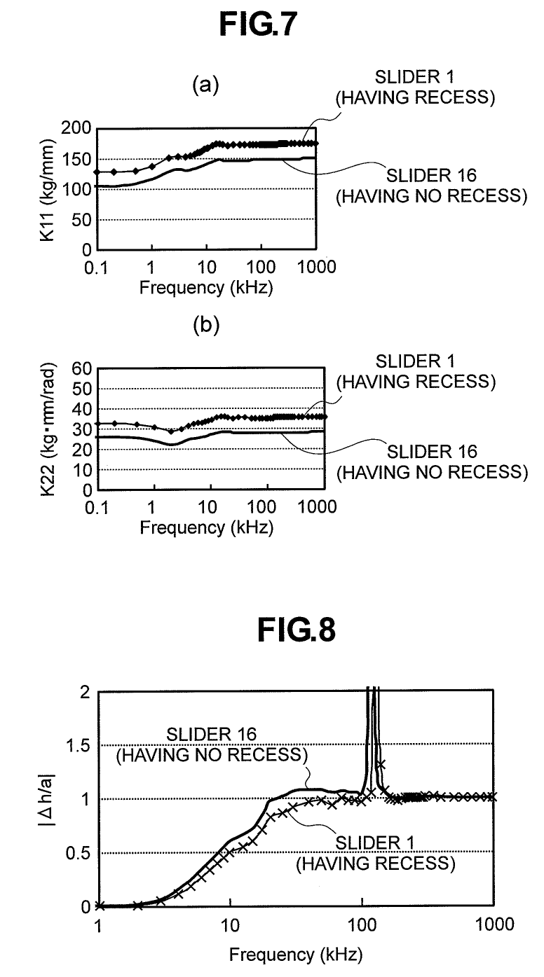

FIGS. 7A and 7B show calculation results of the air film stiffness of the magnetic head sliders 1 and 16 from dynamic analytical calculation of flying of a magnetic head slider. A horizontal axis of FIG. 7A shows frequency, and a vertical axis thereof shows air film stiffness K11 against translational motion in a flying height direction of the slider, and a horizontal axis of FIG. 7B shows frequency, and a vertical axis thereof shows air film stiffness K22 against vibration in a slider pitch direction. In each graph, calculation results for the magnetic head sliders 1 and 16 are plotted in rows. The pitch angle Op and the flying height FH at the read element 8 or the write element 9 were made even respectively between respective analytical models by finely adjusting a shape of the center rail and the like. The height h of the spherical or oval-spherical projection was assumed to be 10 nm, and the recess depth d was assumed to be 5 nm. It is known that the magnetic head slider 1 in Example 1 is improved in the air film stiffness ΔK11 by about 10 to 13%, and in ΔK22 by about 14 to 17% by forming the spherical or oval-spherical projection 12 on the recess portion 14 recessed with respect to the center rail 5 of the center pad.

As described above, according to Example 1, since the spherical or oval-spherical projection 12 including the read element 8 and the write element 9 is disposed on the recess portion 14 being recessed by the depth d with respect to the center rail 5 of the center pad, increase in flying height of the slider base caused by providing the projection 12 having the height h may be suppressed, consequently higher air film stiffness may be secured. Therefore, flying may be stabilized.

During flying of the magnetic head slider, flying height of the magnetic head slider is still varied due to influence of undulation or the like of a magnetic disk. That is, dynamic stability is deteriorated. Particularly, in discrete track media having ultrathin grooves cut on a magnetic disk surface, which is recently progressively developed, even if the grooves are filled by a planarization agent or the like to attempt planarization, undulation of a disk or the like may be increased at large possibility compared with a magnetic disk in the past, therefore magnetic-disk-undulation-following or the like needs to be increased to secure certain dynamic stability of a magnetic head slider. It is said that the air film stiffness between the air-bearing surface of the magnetic head slider and the magnetic disk surface is effectively improved to improve following performance.

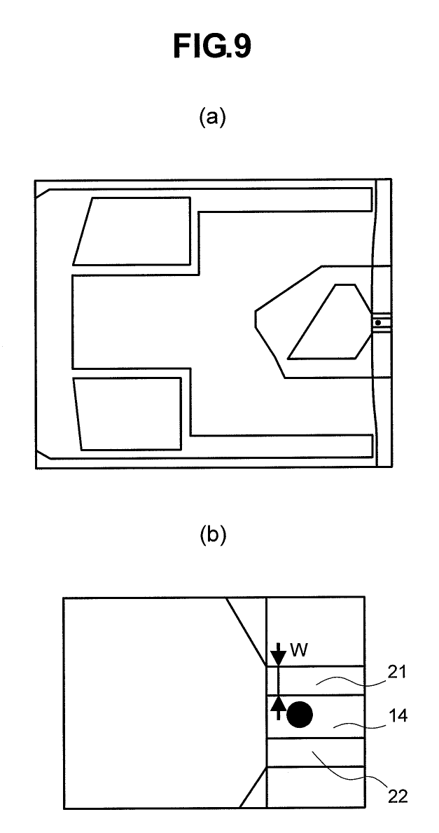

FIG. 8 shows calculation results of the disk-undulation-following of the magnetic head sliders 1 and 16 from dynamic analytical calculation of flying of a magnetic head slider. A horizontal axis shows spatial frequency, and a vertical axis shows a ratio |Δh/a| of anon-following component Ah of a slider to undulation height a of a disk, which means that as the |Δh/a| is smaller, following performance of the slider is better. Since the slider cannot substantially follow disk undulation at high frequency, |Δh/a| has a value of approximately 1 at high frequency. In FIG. 8, calculation results for each of the magnetic head sliders 1 and 16 are plotted together. Since the spherical or oval-spherical projection 12 including the read element 8 and the write element 9 is disposed on the recess portion 14 being recessed by the depth d with respect to the center rail 5 of the center pad according to the example, increase in flying height of the slider base caused by providing the projection 12 having the height h may be suppressed, consequently higher air film stiffness may be secured. As a result, following performance may be stabilized.

In the magnetic head slider 1 of the example, in the center rail 5 of the center pad, width of a center rail, which is by the side of the recess portion 14 being recessed with respect to the center rail, is adjusted, thereby higher air film stiffness may be secured.

Thus, an effect of width adjustment of the center rail by the side of the recess portion 14 is described using FIGS. 9A to 11. FIG. 9A shows a plane diagram of an air-bearing surface of the magnetic head slider 1. FIG. 9B shows an enlarged diagram of an outflow end portion of the plane diagram of FIG. 9A. Analytical calculation was carried out with width W of each of center rail portions 21 and 22 at both sides of the recess portion 14 as a parameter. The pitch angle Op and the flying height FH at the read element 8 or the write element 9 were made even respectively between respective analytical models by finely adjusting a shape of the center rail or the like. The height h of the spherical or oval-spherical projection was assumed to be 10 nm, the recess depth d was assumed to be 5 nm, and width Wr of the recess portion 14 was assumed to be constant.

FIGS. 10A and 10B show calculation results of the air film stiffness between the air-bearing surface of the magnetic head slider and the magnetic disk surface from dynamic analytical calculation of flying of a magnetic head slider with the width W of each of center rail portions 21 and 22 at both sides of the recess portion 14 as the parameter. A horizontal axis of FIG. 10A shows frequency, and a vertical axis thereof shows air film stiffness K11 against translational motion in a flying height direction of the slider, and a horizontal axis of FIG. 10B shows frequency, and a vertical axis thereof shows air film stiffness K22 against vibration in a slider pitch direction. In each graph, analysis results for the magnetic head slider 16 in which the projection 12 is formed on the center rail without recessing the center rail, and for sliders, of which width W of each of center rail portions 21 and 22 at both sides of the recess portion 14 is varied in the magnetic head slider 1 of Example 1, are plotted in rows. It is known that compared with the slider 16 in which the projection 12 is formed on the center rail, the magnetic head slider 1 of Example 1 is improved in air film stiffness even if the width of each of center rail portions 21 and 22 at both sides of the recess portion 14 is zero, that is, even if the center rail portions do not exist at both sides of the recess portion 14, air film stiffness may be improved only by providing the recess. Moreover, it is known that as the width W of each of the center rail portions 21 and 22 at both sides of the recess portion 14 is increased, higher air film stiffness may be secured.

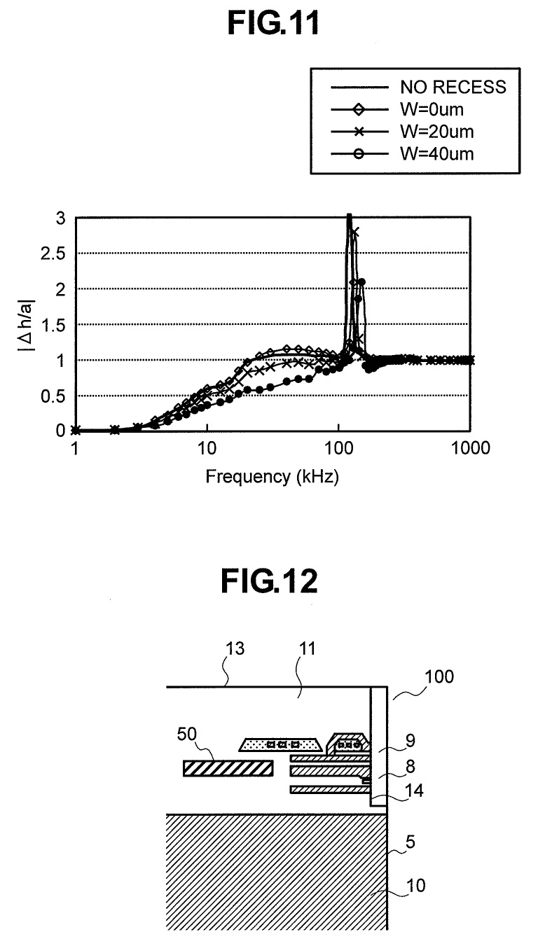

Moreover, in the magnetic head slider 1 of Example 1, disk-undulation-following of the slider may be similarly improved by adjusting width of center rail portions at both sides of the recess portion 14 in the center rail 5 of the center pad. FIG. 11 shows calculation results of the disk-undulation-following from dynamic analytical calculation of flying of a magnetic head slider, in the magnetic head slider 16 in which the projection 12 is formed on the center rail without recessing the center rail, and in sliders of which the width W of each of center rail portions 21 and 22 at both sides of the recess portion 14 is varied in the magnetic head slider 1 of Example 1. It is known that the disk-undulation-following is improved by increasing the width W. This is considered to be due to a synergetic effect of an effect given by improvement in air film stiffness and an effect given by a phenomenon that a pressure center of an air film is moved to an outflow end side of the slider due to increase in width W.

When the width W of each of center rail portions 21 and 22 at both sides of the recess portion 14 is zero, that is, when the center rail portions do not exist at both sides of the recess portion 14, the disk-undulation-following is not improved. This is considered to be because degradation in disk-undulation-following is dominant, which is due to a phenomenon that a pressure center of an air film on the center rail is moved to an inflow end side of the slider by providing the recess on the center rail 5, and thus away from a position of the read element 8 or the write element 9, rather than improvement in following performance due to increase in air film stiffness. For a configuration of the magnetic head slider of Example 1, even if the width W is zero, that is, even if the center rail portions do not exist at both sides of the recess portion 14, a certain effect may be obtained only from a point of air film stiffness, but when disk-undulation-following is further considered, the center rail portions having at least a predetermined width preferably exist at both sides of the recess portion 14.

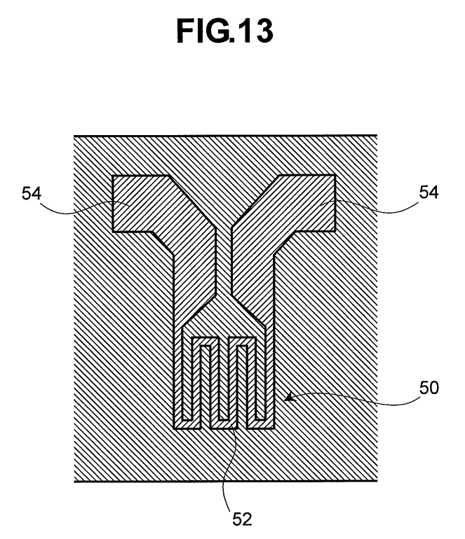

Next, a magnetic head slider 100 according to Example 2 is described with reference to FIG. 12. FIG. 12 shows a sectional diagram of a region near the thin-film magnetic head section 11, which is taken through a center in a longitudinal direction of the slider. Since a general configuration and a shape of an air-bearing surface are essentially the same as in Example 1, only different points from in Example 1 are described. A heater 50 is provided near the read element 8 and the write element 9 of the thin-film magnetic head section 11, and a region including the read element 8 and the write element 9 is recessed by ion milling or the like, thereby the recess portion 14 having a depth of about 5 nm is formed. FIG. 13 shows a plane diagram of the heater 50 seen from a side of the air outflow end face 13. The heater 50 is configured by a heat generation section 52 formed by meandering a thin film resistor and a terminal section 54. The heater 50 is applied with a current to generate heat during magnetic recording/reproducing, thereby the thin-film magnetic head section 11 including the read element 8 and the write element 9 is thermally deformed, and thus projected from the recess portion 14 to have a height more than height of the center rail 5. The projected portion has a spherical or oval-spherical shape as the projection 12 of Example 1, and height from the recess portion 14 is about 10 nm. A shape of the projected portion may be adjusted by a shape or position of the heater 50, and height of the projected portion may be adjusted by the amount of heat generated by the heater 50. While the heater 50 is provided at the back of the read element 8 and the write element 9 in the above description, it may be provided between the read element 8 and the write element 9.

Even in Example 2, a region including the read element and the write element 9 is projected by a height h from the recess portion 14 being recessed by a depth d from the center rail 5 of the center pad, so that the spherical or oval-spherical projected-portion is formed, therefore increase in flying height of a slider base may be suppressed, consequently higher air film stiffness may be secured. Moreover, center rail portions having a certain width or more are provided at both sides of the recess portion 14, thereby the disk-undulation-following may be improved.

What is claimed is:

1. A magnetic head slider, comprising:
a slider,
a thin-film magnetic head formed at an air outflow end of the slider,
a center rail formed on an air-bearing surface of the slider and the thin-film magnetic head,
a recess portion recessed with respect to the center rail,
a spherical or oval-spherical projection formed in the recess portion, which has a height at a position projecting from the center rail, and
a read element and a write element disposed in a position including a peak of the projection.

2. The magnetic head slider according to claim 1,
wherein the projection is formed by processing the air-bearing surface.

3. The magnetic head slider according to claim 1,
wherein the read element has a lower magnetic shield, a magnetoresistive element, and an upper magnetic shield,
the write element is stacked at a side of an air outflow end of the read element, and
the read element and the write element are disposed as a whole in a certain position on the projection.

4. The magnetic head slider according to claim 1,
wherein center rail portions exist at both sides of the projection.

5. A magnetic head slider, comprising:
a slider,
a thin-film magnetic head formed at an air outflow end of the slider,
a center rail formed on an air-bearing surface of the slider and the thin-film magnetic head,
a recess portion recessed with respect to the center rail, and
a read element, write element, and heater disposed in the recess portion.

6. The magnetic head slider according to claim 5,
wherein the read element has a lower magnetic shield, a magnetoresistive element, and an upper magnetic shield,
the write element is stacked at a side of an air outflow end of the read element, and
the read element and the write element are situated as a whole in the recess portion.

7. The magnetic head slider according to claim 5,
wherein a region including the read element and the write element is projected to an air-bearing surface side due to thermal deformation caused by heat generation of the heater, consequently a peak of a projected portion becomes higher than the center rail.

8. The magnetic head slider according to claim 7,
wherein respective ends of the read element and the write element exist near the peak of the projected portion.

9. The magnetic head slider according to claim 5,
wherein the heater is disposed near the read element and the write element.

10. The magnetic head slider according to claim 5,
wherein the heater is disposed between the read element and the write element.
